(19) United States
(12) Patent Application Publication
(10) Pub. No.: US 2025/0326246 A1
(43) Pub. Date: Oct. 23, 2025

(54) MULTIFUNCTIONAL GEOMETRY TOOL

(71) Applicant: Nagaraj PRAVEEN, Sullia (IN)

(72) Inventor: Nagaraj PRAVEEN, Sullia (IN)

(21) Appl. No.: 19/256,996

(22) Filed: Jul. 1, 2025

(51) Int. Cl. B43L 9/04; B43L 9/00; B43L 9/12; B43L 9/20; B43L 9/24

(52) U.S. Cl. CPC B43L 9/04; B43L 9/007; B43L 9/12; B43L 9/20; B43L 9/24

(57) ABSTRACT

The present invention relates to an integrated multifunctional geometry device. The device comprises an elongated scale body with measurement markings, a centrally mounted movable slider configured to hold a pencil or pen, and a twist-lock pin at one end to act as a rotational pivot, wherein by adjusting the slider, users can draw circles, arcs, bisect lines or angles, and also draw straight lines with accuracy and efficiency. The proposed device can be used as a compass, ruler, divider, and pencil holder, wherein the device has advantages in terms of speed, safety, compactness, and usability, making the device particularly suited for educational environments and exam settings.

### FIELD OF THE INVENTION

The present disclosure relates to the field of educational tool and drawings instrument, specifically to an integrated multi-functional geometry device, designed for school students, teachers, technical professionals, and exam aspirants. The present invention aims to address the standing limitation of traditional geometric toolkit or device, by considering multiple functional operations into a single compact tool, offering ease of use, enhanced accuracy, reduced preparation time, and improved safety.

### BACKGROUND OF THE INVENTION

Traditional geometry boxes contain separate tools for performing individual geometric functions such as drawing lines (ruler), circles (compass), transferring distances (divider), and measuring angles (protractor/set square). This fragmented approach not only consumes space but also time, especially in time-sensitive environments such as competitive examinations or practical geometry tests. The transition between tools is cumbersome, often prone to misalignment, and requires prior practice for achieving precision.

Additionally, the safety risks of using conventional compasses and dividers with their sharp, pointed metal ends are well documented. Schools and colleges frequently report incidents involving misuse or accidental injuries due to such instruments. These risks make them less suitable for younger students or those lacking proper supervision. Furthermore, drawing accurate and consistent circles or bisecting angles using a traditional compass involves multiple manual steps and fine adjustments, often resulting in inconsistencies.

There has been very little inventive step in the fundamental functionality of geometry instruments over the past several decades. Most advancements have focused only on material changes (metal to plastic, for instance), without addressing the functional inefficiencies, user experience, or safety concerns associated with traditional tools. This clearly demonstrates that there is an unmet need for a multi-functional geometrical tool. This invention addresses this need by developing a unified, compact, easy-to-use, and safe alternative that performs all essential geometric operations through a single, integrated device.

The multifunctional geometry device, proposed in this invention, is developed as a response to the need for a faster, safer, and more intuitive geometry tool, especially suited for students. The device facilitates safe, swift, accurate, and easy use, allowing drawing circles, arcs, bisecting lines or angles, and drawing straight lines all without switching between instruments. The device eliminates setup time and increases precision, saving up to 70% of operational time in geometry drawing tasks.

### SUMMARY OF THE INVENTION

The present disclosure relates to an integrated multi-functional geometry device, designed for school students, teachers, technical professionals, and exam aspirants. The multi-functional geometrical drawing device is capable of performing the functions of a compass, ruler, divider, and pencil holder, wherein all these features are integrated into a single device. This invention eliminates the need for a traditional geometry box containing multiple individual tools. The multifunctional instrument comprises an elongated scale body with measurement markings, a centrally mounted movable slider configured to hold a pencil or pen, and a twist-lock pin at one end to act as a rotational pivot. By adjusting the slider, users can draw circles, arcs, bisect lines or angles, and also draw straight lines with accuracy and efficiency. The multifunctional geometry tool provides significant advantages in terms of speed, safety, compactness, and usability, particularly suited for educational environments and exam settings.

An object of the present disclosure is to provide an integrated multi-functional geometry device, designed for school students, teachers, technical professionals, and exam aspirants.

Another object of the present disclosure is to provide a multi-functional geometrical device that can be used as a ruler, compass, divider, for bisecting angles or lines, and pencil holder.

Another object of the present disclosure is to provide a multi-functional geometrical device, providing significant advantages over traditional devices, in term of speed, safety, compactness, and usability, particularly suited for educational environments and exam setting.

Yet, another object of the present disclosure is to address the limitation of traditional geometry box containing multiple individual tools.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates displays a block diagram of a Multifunctional Geometry Tool, in accordance with an embodiment of the present disclosure;

FIG. 2 illustrates a drawing depicting the front view of the device, in accordance with an embodiment of the present disclosure;

FIG. 3 illustrates a drawing depicting the back view of the device, in accordance with an embodiment of the present disclosure;

FIG. 4 illustrates a drawing depicting the top view of the device, in accordance with an embodiment of the present disclosure;

FIG. 5 illustrates a drawing depicting the bottom view of the device, in accordance with an embodiment of the present disclosure;

FIG. 6 illustrates a drawing depicting the right side view of the device, in accordance with an embodiment of the present disclosure;

FIG. 7 illustrates a drawing depicting the left side view of the device, in accordance with an embodiment of the present disclosure;

FIG. 8 illustrates a drawing depicting the perspective view of the device, in accordance with an embodiment of the present disclosure; and

FIG. 9 illustrates a table showing the specification of the integrated multi-functional geometry device, in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

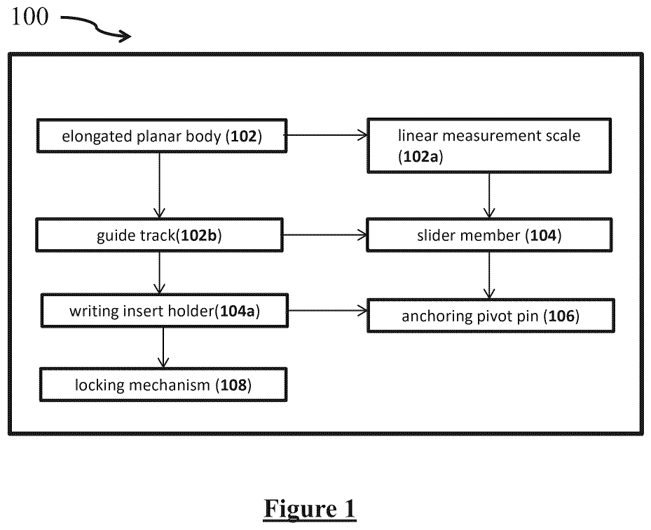

Referring to FIG. 1, a block diagram of a multifunctional geometry tool is illustrated. The system 100 comprises: an elongated planar body (102) having a linear measurement scale (102a) marked along at least one surface, the body comprising a top face, a bottom face, a longitudinal central axis, and a guide track (102b) disposed along said axis; a slider member (104) mounted within the guide track and configured to translate along the longitudinal axis, wherein the slider member comprises a writing insert holder (104a) configured to retain a pencil, pen, or marking element; an anchoring pivot pin (106) disposed proximate to a first end of the elongated planar body, the pin being secured within a cavity or recess aligned at or near the zeroth mark of the linear scale, and a locking mechanism (108) integrated with the slider member, configured to selectively fix the position of the writing insert relative to the pivot pin, wherein the slider member and anchoring pivot pin together define a radial arm allowing the instrument to perform circular and arc-drawing operations, line bisecting, and distance transferring tasks by rotational movement of the writing insert around the anchoring pin.

In an embodiment, the linear measurement scale (102a) includes both metric units up to 15 centimeters and imperial units up to 6 inches, wherein the pivot pin comprises a stainless steel rod having a diameter in the range of 2.5 mm to 3.5 mm, and is held within a recessed conical socket formed in the body to allow stable rotational anchoring; and wherein the writing insert holder comprises a cylindrical cavity formed within the slider and a compression fit or clamping mechanism to secure various marking instruments selected from pencils, pen refills, mechanical pencils, or styluses.

In this embodiment, the multifunctional geometry instrument is designed to be compatible with both the metric and imperial systems of measurement, making it universally usable across different educational or professional contexts. The linear scale (102a), which is marked along the elongated planar body, is precisely engraved or printed to reflect metric units up to 15 centimeters on one edge and imperial units up to 6 inches on the opposite edge. This dual-format measurement scale allows users—such as students, architects, or engineers—to work across different standards without needing to switch tools or perform conversions. For example, an international student working on geometry problems in both metric and imperial units can seamlessly switch between measurement systems using the same instrument.

To ensure precise and stable operation during compass-like activities, the anchoring pivot pin is formed from a stainless steel rod with a controlled diameter ranging from 2.5 mm to 3.5 mm. This specific diameter range balances mechanical strength with minimal obstruction and ensures compatibility with standard machining tolerances. The pin is inserted into a conical recess or socket molded into the instrument's body at or near the zero mark of the linear scale. The conical geometry of the socket provides a self-centering effect and helps distribute radial forces evenly around the pin during rotation. As a result, when the user rotates the slider around the anchored pin, the drawing radius remains consistent without lateral deviation or wobble, thereby enabling clean and accurate arc or circle construction.

The writing insert holder-housed within the slider-features a cylindrical cavity designed to accept a wide variety of marking tools. The cavity is dimensioned to accommodate standard writing instruments such as wooden pencils, mechanical pencils, pen refills, and even styluses used on digital surfaces. To secure these instruments firmly, the cavity incorporates a compression-fit or clamping mechanism. This may be realized through an internal elastomer sleeve that expands around the tool, or through a manually operated clamping element such as a thumb screw or cam lock. This ensures that the inserted tool does not wobble or shift during use, preserving both the alignment and rotational integrity required for precise geometrical constructions. For instance, if a user wishes to switch between a 0.5 mm mechanical pencil for fine lines and a gel pen for bold lines, the compression fit allows quick and stable replacement without compromising drawing accuracy.

In an embodiment, the slider member (104) further comprises a grip knob disposed on an upper surface, and a recessed cavity aligned orthogonally to the guide track for improved ergonomic handling and vertical pressure application during use; wherein the locking mechanism comprises a friction-based twist-lock system or detent latch that enables discrete positional locking of the slider along predefined measurement intervals; and wherein the body is fabricated from semi-transparent polycarbonate plastic with rounded corners and softened edges, and wherein the entire instrument has a total weight not exceeding 20 grams for improved portability and safe handling by children.

In this embodiment, the slider member (104) is further enhanced with features that significantly improve user comfort, grip, and operational precision. At the top of the slider, a grip knob is provided, protruding sufficiently to be easily grasped and manipulated by the user's fingers. This grip knob serves as the primary interface for moving and positioning the slider along the guide track. To further augment control and pressure distribution, a recessed cavity is formed beneath the grip knob and oriented orthogonally to the track's longitudinal axis. This recessed cavity allows the user to rest their fingertip in a natural ergonomic position, enabling stable application of vertical pressure directly over the center of the slider. As a result, whether the instrument is being used to draw circles, arcs, or straight lines, the user can maintain consistent contact between the marking instrument and the drawing surface, minimizing slip or lift.

The locking mechanism within the slider is designed for intuitive and reliable use. It may be realized through a friction-based twist-lock system—wherein the user rotates the grip knob or an integrated dial to tighten the slider in place—or through a detent latch mechanism that clicks into predefined positions along the guide track. These positions may correspond to standard intervals (e.g., every 1 mm or 1/16 inch) marked on the scale, enabling repeatable and precise setting of radial distances or linear positions. This ensures that during compass operation or when transferring distances, the slider remains fixed and does not drift due to vibration or hand pressure, which is critical in accurate geometric constructions.

The entire instrument body is manufactured from semi-transparent polycarbonate plastic, a material selected for its lightweight, high-impact resistance, and aesthetic appeal. The transparency allows partial visibility of markings or drawings underneath the instrument, aiding alignment and reducing parallax errors. The edges and corners of the instrument are rounded and softened to avoid sharpness, which is particularly beneficial for younger users or classroom settings where safety is a concern. Additionally, the total mass of the instrument is constrained to less than 20 grams, making it extremely portable and comfortable for prolonged use. The low weight reduces user fatigue and allows safe handling by children, while still maintaining sufficient structural rigidity for stable operation. For example, in a school environment, a student can carry the tool in a pencil case and use it across subjects-geometry, technical drawing, or design-without the need for multiple instruments.

In an embodiment, the elongated planar body (102) is configured to be tilted slightly and supported on the slider and the pivot end to allow stable drawing of straight lines when used in ruler mode; wherein the slider and anchoring pin are configured such that rotational displacement of the slider about the pin allows for drawing of concentric or overlapping arcs by adjusting the radial distance via the guide track; and wherein the slider mechanism enables drawing of intersecting arcs from two or more reference points for the purpose of bisecting an angle or a linear segment, emulating the functionality of a traditional compass and divider combination.

In this embodiment, the multifunctional geometry instrument is designed with structural features that enhance its dual-purpose functionality as both a straight-edge ruler and a dynamic compass/divider tool. The elongated planar body (102) is engineered to allow a slight tilt when resting on a flat surface. This tilt is achieved through the elevation provided by the anchored pivot pin at one end and the raised body of the slider at the other. This configuration creates a small angular inclination that ensures the bottom edge of the body makes clean, uninterrupted contact with the drawing surface when used to draw straight lines in ruler mode. The tilt also reduces friction along the entire length of the ruler, improving line accuracy and visibility for the user, especially in precise technical drawings or classroom activities where clarity and alignment are essential.

Further, the mechanical cooperation between the slider and the anchoring pin enables a dynamic compass mode. When the pivot pin is fixed into the drawing surface, the user can rotate the slider about this anchored point. Since the slider can translate along the guide track, changing its distance from the pivot pin adjusts the radius of the arc or circle to be drawn. This radial adjustment, combined with the fixed central pivot, allows for the construction of multiple concentric or overlapping arcs with different radii—an operation commonly required in geometric constructions or design tasks such as layering decorative curves or plotting equidistant curves in technical sketches.

Moreover, the slider mechanism supports geometric constructions involving intersecting arcs. For example, to bisect a given angle or linear segment, the user can place the pivot pin at one reference point and draw an arc, then reposition the instrument to a second reference point and draw a second arc that intersects the first. The intersection of these arcs defines a point along the angle bisector or perpendicular bisector of a line segment. This mimics the traditional functionality of using a compass and divider, where a user would physically measure, swing arcs, and transfer distances to solve geometric problems. The integrated slider and guide track in this embodiment streamline that process, allowing accurate and repeatable operations using a single multifunctional device. This not only simplifies the workflow but also reduces the need for multiple separate tools, making the instrument ideal for students, architects, and engineers alike.

In an embodiment, the slider member (104) is mechanically coupled to the guide track by a pair of opposed lateral protrusions extending orthogonally from the slider base into corresponding longitudinal retention channels formed within the inner sidewalls of the guide track, wherein said protrusions are dimensioned to provide a snap-fit engagement allowing translational movement with axial constraint, wherein the engagement further provides anti-lift resistance to prevent unintentional detachment of the slider from the body during operational use involving torsional forces; and wherein the retention channels of the guide track include a series of detent notches or micro-indentations spaced along the length of the track, wherein a spring-loaded ball plunger is embedded within the slider base and configured to engage said notches to allow tactile feedback and discrete radial locking during use as a compass, wherein the plunger is biased by a compressible elastomeric pad or coiled micro-spring positioned within a vertical recess of the slider base to provide adjustable locking resistance.

In this embodiment, the structural integration of the slider member (104) with the guide track is meticulously engineered to ensure smooth, precise motion while maintaining robust mechanical stability during usage. The base of the slider is equipped with a pair of opposed lateral protrusions that extend perpendicularly into the body of the guide track. These protrusions interface with longitudinal retention channels molded into the inner sidewalls of the track, forming a mechanically interlocked structure. The dimensions of the protrusions are carefully calibrated to achieve a snap-fit engagement-tight enough to ensure the slider does not rattle or loosen over time, yet sufficiently flexible to allow smooth translational movement along the track's axis.

This snap-fit connection not only constrains the slider's motion to a linear path but also provides anti-lift resistance. That is, even when the slider is subjected to upward forces—such as when the user presses the writing tool down and simultaneously rotates it during compass operation—the engagement prevents the slider from detaching or wobbling out of place. This anti-lift feature is critical for maintaining consistent marking pressure and accurate arc geometry, particularly during rotational use where torsional forces are commonly encountered.

To further enhance functional precision and user control, the retention channels within the guide track are embedded with a sequence of detent notches or micro-indentations spaced at uniform intervals along the track's length. These notches are configured to interact with a spring-loaded ball plunger located in the base of the slider. As the slider moves along the track, the ball plunger intermittently clicks into these detents, providing the user with tactile feedback at each discrete radial setting. This click-based feedback not only helps the user feel the positioning without looking away from the work surface but also serves to temporarily hold the slider in position, which is particularly useful when the instrument is being used to draw circles or arcs with specific radii.

The force and responsiveness of this ball plunger system are regulated by a compressible elastomeric pad or a coiled micro-spring housed within a vertical cavity inside the slider base. Depending on the material choice and preload configuration, the resistance can be tuned to achieve a balance between ease of adjustment and firm positional locking. For example, a user drawing a series of arcs with progressively increasing radii can feel and hear each increment as the slider advances, enhancing the tactile intuitiveness of the device. This embodiment thus ensures that the slider remains reliably aligned, securely retained, and intuitively adjustable, even during demanding usage scenarios such as repeated geometric constructions or prolonged compass operation.

In an embodiment, the writing insert holder (104a) comprises a vertically oriented clamping cavity defined by two opposing semi-cylindrical jaws, wherein the jaws are connected via an integrated hinge joint and tightened by a micro-threaded screw accessible from the top surface of the slider, wherein the screw drives a compressive plate that applies symmetrical force across the inner walls of the cavity to secure marking instruments of varying diameters without inducing lateral wobble during rotation; and wherein the integrated hinge joint comprises a flexural web formed from a living hinge geometry molded as a single piece with the slider body, wherein said hinge exhibits elastic deformation limited to a maximum angular deflection of 15 degrees on either side of neutral to facilitate controlled opening and closing of the clamp cavity, wherein the web is oriented orthogonal to the direction of slider translation to preserve axial alignment of the writing instrument.

In this embodiment, the writing insert holder (104a) is designed with a high-precision clamping mechanism to securely accommodate a variety of marking instruments—such as pencils, pens, styluses, and refills—while maintaining accurate alignment and rotational stability during use. The clamping mechanism is built around a vertically oriented cavity defined by two opposing semi-cylindrical jaws that form a near-circular internal enclosure when closed. These jaws are mechanically integrated into the slider via a flexible hinge joint, allowing them to open and close in a controlled manner to receive and retain different writing implements.

The jaws are joined at their base by an integrated hinge structure formed using a flexural web—a continuous, thin section of material that behaves like a “living hinge.” This web is molded from the same material as the slider body during a single manufacturing process, ensuring monolithic integrity and eliminating the need for additional components or fasteners. The hinge is oriented orthogonal to the direction of slider translation, meaning that it flexes laterally relative to the slider's movement path. This design ensures that the motion of opening and closing the jaws does not disturb the axial position of the writing instrument, which is essential for preserving precise radial alignment during compass operations.

To actuate the clamping mechanism, a micro-threaded screw is embedded vertically within the slider and is accessible from the top surface. As the user turns this screw, it drives a compressive plate downward into the space between the jaws, forcing them to close symmetrically. This controlled, even pressure applies uniform force along the circumference of the inserted tool, thereby eliminating lateral wobble or tilt during rotation. This is particularly important when drawing arcs or circles, where even a minor misalignment can result in significant deviation from the intended geometry.

The flexural hinge is engineered to allow angular deflection up to ±15 degrees from its neutral position, providing just enough motion to accommodate common writing tool diameters while ensuring the integrity and memory of the hinge over repeated cycles. Because the jaws return to a neutral aligned position after each opening, the cavity remains coaxially aligned with the slider's central axis, preserving the precise geometry required for accurate drawing.

For example, a user may wish to insert a 0.7 mm mechanical pencil for fine line work, followed by a larger-diameter felt pen for bolder arcs. This embodiment enables seamless swapping without the need for external adapters or excessive tightening, while still guaranteeing that both instruments are held rigidly during rotation. Overall, this design combines structural precision, ergonomic usability, and long-term durability in a compact and integrally molded assembly.

In an embodiment, the anchoring pivot pin (106) is coupled to a recessed rotary locking collar housed within a cylindrical cavity formed into the instrument body, wherein the collar includes a plurality of radial ridges configured to engage a corresponding toothed raceway embedded in the body cavity wall, wherein rotational tightening of the collar by a user compresses the collar axially to lock the pin in place, while counter-rotation releases the engagement to permit safe retraction or repositioning of the pin; and wherein the pivot pin is integrally connected to a vertical shaft extending below the instrument body and terminating in a hemispherical footpad configured to rest flush against a drawing surface, wherein said footpad is surrounded by a silicone or elastomeric gasket ring bonded to the base of the body cavity, wherein the gasket ring provides both frictional anchoring during compass operation and shock absorption to prevent slippage when rotational torque is applied via the slider.

In this embodiment, the anchoring pivot pin (106) is integrated into a highly stable and secure mounting system that ensures both precise functionality during compass operation and safe adjustability when the pin is not in use. The pivot pin is mechanically connected to a recessed rotary locking collar, which is seated within a cylindrical cavity machined or molded directly into the instrument body. This collar features a series of radial ridges on its exterior surface, designed to engage with a corresponding toothed raceway embedded along the inner wall of the cavity. When the user manually rotates the collar in a clockwise direction, these ridges interlock with the raceway, and the resulting mechanical engagement translates the rotational motion into axial compression of the collar. This axial compression effectively clamps the pivot pin into a fixed vertical position, preventing any play or wobble during operation.

Conversely, rotating the collar in the opposite (counter-clockwise) direction disengages the ridges from the toothed raceway, releasing the axial pressure and allowing the user to either retract the pivot pin or reposition it as needed. This locking mechanism provides an intuitive and tool-free method for securing or adjusting the pivot pin, which is particularly beneficial during transitions between drawing modes (e.g., switching from straightedge use to compass use).

The pivot pin itself is integrally connected to a vertical shaft that extends downward through the body of the instrument. At its terminal end, the shaft is fitted with a hemispherical footpad, which rests directly against the drawing surface when the pin is deployed. This hemispherical shape ensures consistent contact regardless of slight variations in surface angle or material texture, thereby maintaining a fixed pivot center during arc or circle drawing.

Surrounding the footpad is a soft silicone or elastomeric gasket ring, which is permanently bonded to the base of the cylindrical cavity in the instrument body. This gasket serves dual purposes: it provides frictional resistance to minimize sliding or shifting of the instrument during compass operation, and it acts as a shock absorber, damping the small vibrations or torque impulses that may arise as the user rotates the slider around the anchored pivot. For example, when a student draws a large-radius circle with steady angular motion, the gasket ensures that the central pivot remains immobile despite torsional stress, resulting in clean and precise arcs. Additionally, this frictional anchoring is particularly advantageous on smooth or laminated surfaces, where conventional compasses often tend to slip. The inclusion of the elastomeric material thus significantly enhances both the safety and operational stability of the instrument.

In an embodiment, the guide track (102b) includes a secondary alignment rib projecting upward from the track base and extending longitudinally along its centerline, wherein the slider comprises a matching channel that mates with the rib to constrain motion strictly along a linear axis, wherein the interaction of the rib and channel prevents skew or torsional misalignment of the slider during force-intensive rotational usage in compass or bisecting mode; and wherein the slider includes dual lateral stabilization fins extending downward from its base, said fins being received in corresponding vertical grooves within the track walls, wherein the combination of fins and the central alignment rib forms a three-point kinematic constraint system that preserves planarity of motion and maintains orthogonality of the writing axis during all drawing operations.

In this embodiment, the guide track (102b) and the slider are engineered with a precision-aligned interlocking geometry that ensures highly constrained and stable movement, essential for the accuracy and repeatability of geometric constructions. The guide track features a secondary alignment rib, a raised structural element that projects upward from the track base and runs longitudinally along the central axis of the track. This rib is received into a precisely dimensioned channel formed on the underside of the slider, creating a keyed fit that enforces strict linear guidance. The rib-channel interface acts as a central guide rail, preventing the slider from deviating laterally or rotating off-axis as it translates along the length of the guide track.

This constrained motion is critical in maintaining the mechanical fidelity of the instrument during operations that involve angular force application, such as drawing arcs or bisecting angles. For instance, when a user applies rotational pressure to the slider in compass mode—pivoting the slider about the fixed anchoring pin to scribe a circular arc—the alignment rib ensures that the slider does not twist or skew under torsional stress, thereby preserving the radial alignment of the writing insert relative to the pivot point.

To further augment the mechanical constraint system, the slider is equipped with a pair of lateral stabilization fins that extend vertically downward from its base. These fins engage with matching vertical grooves machined or molded into the inner walls of the guide track. As the slider moves, these fins remain nested within the grooves, adding lateral bracing that prevents side-to-side wobble or tilt. The combination of these two guidance features—the central rib/channel pair and the side fins/grooves—forms a three-point kinematic constraint system. In mechanical design, a three-point constraint system is known for providing a statically determinate, rigid configuration that controls all degrees of freedom except the intended direction of motion.

This system ensures that the slider remains flush against the guide track surface and maintains orthogonality of the writing axis (i.e., the pencil or pen stays perfectly vertical relative to the drawing surface) throughout the slider's travel range. This is especially important in tasks requiring high accuracy, such as transferring distances or drawing concentric arcs with minimal radial error. For example, when constructing geometrical figures that involve multiple intersecting arcs—such as hexagons, angle bisectors, or perpendicular bisectors—the rigid constraint system ensures each arc originates from a perfectly aligned and calibrated point, thereby eliminating cumulative errors caused by tool misalignment. The embodiment thus ensures the multifunctional instrument performs with the precision expected of professional-grade geometry tools while remaining compact and user-friendly.

In an embodiment, the slider (104) is equipped with a torsion spring-loaded ratcheting disk mounted coaxially with the writing insert holder, wherein the ratcheting disk includes a series of radial teeth configured to engage a locking pawl mounted within the slider housing, wherein selective depression of a release button on the slider disengages the pawl, allowing rotational repositioning of the writing insert holder to facilitate oblique line or angled arc drawing.

In this embodiment, the slider (104) is enhanced with a rotational adjustment mechanism designed to provide users with fine control over the angular orientation of the writing insert holder. Central to this feature is a torsion spring-loaded ratcheting disk, which is mounted coaxially with the writing insert holder inside the slider assembly. The ratcheting disk is engineered with an array of radial teeth uniformly distributed around its circumference. These teeth are mechanically interfaced with a locking pawl that is securely mounted within the interior of the slider housing.

Under normal operation, the pawl remains engaged with the ratcheting disk, thereby holding the writing insert holder in a fixed angular position relative to the slider body. This default locked state ensures that the writing tool does not rotate unintentionally during usage, particularly in operations involving circular or arc drawing, where rotational accuracy of the tip is critical. For instance, if a user is drawing a consistent-radius arc, the writing instrument must maintain its orientation throughout the sweep to ensure a smooth, uninterrupted line.

To enable angular repositioning of the writing insert holder, the user may press a release button located on the outer surface of the slider. When depressed, this button actuates a small cam or lever mechanism that momentarily disengages the locking pawl from the ratcheting disk's teeth. This releases the angular constraint, allowing the user to manually rotate the writing insert holder to a desired angle. Upon releasing the button, the torsion spring biases the pawl back into engagement with the nearest ratchet tooth, locking the new angular position in place with audible and tactile feedback.

This mechanism is particularly beneficial when the user needs to draw oblique lines or angled arcs-such as when constructing tangents, angular rays, or segments that deviate from orthogonal geometries. For example, in a geometric proof or design sketch requiring lines at 45°, 60°, or custom angles, the user can quickly rotate the writing tool to the desired orientation without removing it from the holder or adjusting the instrument's base alignment.

The ratcheting mechanism ensures that the rotation occurs in discrete increments, typically around 10-15°, providing both precision and repeatability. By combining ease of adjustability with secure locking, this embodiment significantly extends the versatility of the instrument while preserving mechanical robustness and drawing accuracy.

In an embodiment, the slider (104) is mechanically connected to a tension-biased positioning mechanism comprising an internal helical spring coupled between a fixed anchor post embedded within the guide track and a rearward-facing tab extending from the slider body, wherein the spring applies a return force to bias the slider toward the anchoring pivot when no external force is applied, wherein said mechanism provides automated radial reset after each arc or circle drawing operation to enhance efficiency in repeated constructions.

In this embodiment, the slider (104) is integrated with an automatic repositioning mechanism that leverages a tension-biased return system to streamline repetitive geometric constructions, particularly when drawing multiple arcs or circles. At the heart of this system is an internal helical spring, which is configured to apply continuous tension between two key structural elements: a fixed anchor post embedded within the guide track and a rearward-facing tab that extends from the slider's rear edge.

The fixed anchor post is securely mounted within the track body, ensuring it remains stationary during all operational use. The helical spring is stretched between this post and the rearward tab on the slider body, such that any movement of the slider away from the anchoring pivot point (i.e., as the user increases the radius of an arc or circle) results in the spring being further tensioned. Once the external force applied by the user is released—such as when the user lifts their hand or completes a circular stroke—the stored potential energy in the stretched spring acts to pull the slider back toward the anchoring pivot.

This return movement is linear and occurs along the guide track, effectively resetting the slider to its initial position. This automated radial reset functionality dramatically increases efficiency in use cases that involve repeated drawing of arcs or circles from the same center point. For instance, in the construction of concentric patterns, polygonal segmentations, or stepwise radial measurements, the user can draw an arc, release the slider, and allow it to return automatically to the base position-eliminating the need for manual repositioning and ensuring a consistent starting radius for each iteration.

Moreover, the return force is calibrated to be gentle yet decisive; it is strong enough to return the slider without user intervention but not so forceful that it jerks or disrupts the marking implement's contact with the drawing surface. The mechanism also helps prevent accidental forward slippage of the slider during compass operation, maintaining controlled radial positioning throughout the arc drawing process. This embodiment not only enhances usability and workflow speed but also ensures repeatable accuracy, making the multifunctional geometry instrument especially valuable in educational, drafting, and design contexts where repetitive constructions are frequent.

In an embodiment, the slider (104) comprises an integrated dial indicator positioned adjacent to the linear scale and operably connected to the slider's translational position via a rack-and-pinion mechanism, wherein the rack is embedded along the underside of the guide track, and the pinion is rotationally mounted within the slider and configured to drive the indicator dial, wherein the dial dynamically displays real-time radius values as the slider is moved, enabling precise and immediate radius setting without manual reading of the linear scale.

In this embodiment, the slider (104) incorporates a precision feedback mechanism in the form of an integrated dial indicator, which enhances the user's ability to determine and adjust the radial distance of the writing insert from the anchoring pivot pin with high accuracy and minimal effort. This dial indicator is mounted directly on the slider's upper surface, in close proximity to the linear measurement scale marked on the elongated body of the instrument. However, rather than requiring the user to visually align the slider's position with the scale markings—which can be error-prone due to parallax effects or misjudged alignment—the dial provides a dynamic, real-time readout of the current radial value.

This functionality is enabled through a rack-and-pinion mechanism that translates the linear motion of the slider into rotary motion for the dial. Specifically, a finely toothed rack is embedded along the underside of the guide track, aligned parallel to its longitudinal axis. As the slider moves back and forth along the track, a meshing pinion gear—rotationally mounted within the slider body—engages with the rack teeth. The pinion turns in direct proportion to the slider's displacement and is mechanically linked to the dial indicator, which is calibrated to display radius values corresponding to the distance from the pivot point to the writing insert holder.

As a result, any movement of the slider is instantly reflected in the position of the indicator needle or digital readout on the dial. This continuous feedback allows the user to make fine adjustments without having to shift their line of sight or estimate values from the printed scale. For example, if a user wishes to draw a circle with an exact radius of 6.5 cm, they can simply move the slider until the dial reads 6.5, ensuring precision without approximation. This is particularly advantageous in technical drawing, drafting, and geometric construction tasks that demand accuracy within tight tolerances.

The dial mechanism is robustly housed to protect it from mechanical stress, and the pinion is mounted on a low-friction axle to ensure smooth rotation and consistent engagement with the rack. The entire assembly is designed to function reliably over prolonged use, with minimal wear or calibration drift. This embodiment thus transforms the instrument from a passive measuring tool into an actively responsive device, facilitating higher drawing precision, reducing user error, and making complex constructions more efficient and intuitive.

In an embodiment, the writing insert holder (104a) is further configured with an angular indexing feature comprising a rotary turret with a detented rotational mount, wherein the turret allows selectable angular orientations of the writing implement in fixed increments of 15°, wherein each angular position is maintained by engagement of a spring-biased indexing pin with a corresponding radial groove formed on the turret's periphery.

In this embodiment, the writing insert holder (104a) is engineered with an angular indexing feature that enables the user to precisely set and lock the orientation of the marking instrument at discrete angular increments. This is achieved through the integration of a rotary turret, which serves as the mounting interface for the writing tool. The turret is rotatably mounted within the slider and is supported by a detented rotational system, allowing it to rotate about its axis while maintaining structural stability and alignment.

The outer periphery of the turret is formed with a series of evenly spaced radial grooves, each corresponding to a specific angular position—typically set at 15° increments, yielding 24 discrete positions over a full 360° rotation. These grooves serve as mechanical catch points for an internal spring-biased indexing pin housed within the slider structure. The pin is designed to move radially inward under the influence of a compression spring and engage with the grooves as the turret rotates. Once the pin settles into a groove, the turret is held firmly at that angle, preventing unintentional rotation during use.

To adjust the angular position of the writing instrument, the user simply applies rotational force to the turret. As the turret is turned, the indexing pin is momentarily displaced by the ramped edges between adjacent grooves. The spring automatically biases the pin back into the next groove once alignment is achieved, locking the turret into the new angular setting. This mechanism provides clear tactile feedback—often accompanied by a clicking sensation—indicating successful engagement and ensuring the user knows when the orientation has been precisely indexed.

The angular indexing system is particularly useful when drawing inclined lines, angled arcs, or radiating patterns that require the writing implement to be oriented at a specific angle with respect to the instrument's body. For example, a user constructing a star-shaped figure, radial grid, or a technical drawing involving rays at multiple fixed angles can easily rotate the writing implement to a 45°, 90°, or 135° position without guesswork. Additionally, the firm engagement of the indexing pin prevents any shift in orientation due to operational torque, ensuring the consistency of the angle throughout the drawing stroke. This embodiment significantly enhances the geometric versatility of the instrument by allowing not only control over position and radius but also over directional orientation of the marking tip.

In an embodiment, the guide track (102b) is segmented into a primary linear slot and two lateral stabilization grooves, wherein the underside of the slider includes a central gliding rail and two flexible lateral arms extending downward from either side, wherein each flexible arm includes a convex cam surface that presses against the groove wall to induce elastic preload, wherein said configuration allows damping of mechanical vibration and stabilizes motion during rapid drawing actions, thereby enhancing precision.

In this embodiment, the guide track (102b) is structurally segmented to create a multi-channel alignment system that enhances the mechanical stability and operational smoothness of the slider during both linear and rotational movements. Specifically, the guide track is divided into a central primary linear slot flanked by two lateral stabilization grooves. The primary slot accommodates the central gliding rail of the slider, which ensures accurate translational movement along the longitudinal axis of the instrument. The lateral grooves serve as receptacles for additional stabilization components that contribute to motion control and vibration damping.

On the underside of the slider, a central gliding rail projects downward and fits snugly within the primary linear slot of the track. This rail forms the main load-bearing interface for the slider and ensures that its path of motion remains strictly linear. On either side of this central rail, the slider includes two flexible lateral arms that extend downward into the corresponding stabilization grooves of the guide track. These arms are fabricated from resilient polymeric material and are integrally molded with the slider body to ensure durability and long-term deformation resistance.

Each flexible arm features a convex cam surface that is specifically contoured to press against the inner wall of the corresponding lateral groove. This contact induces an elastic preload the arms are slightly compressed inward as they enter the grooves-generating a controlled outward force that maintains constant contact with the groove walls. This elastic interaction acts as a passive damping mechanism that absorbs minute mechanical vibrations and lateral shocks that can occur during rapid or forceful drawing actions, such as fast circular strokes or quick ruler passes.

The result is a dynamically stabilized slider system that resists jitter, chatter, or lateral wobble. This is especially critical in high-precision applications like technical drawing, geometric constructions, or drafting exercises where even a minor deviation can lead to significant inaccuracies. For instance, when a student is drawing a bisecting arc from two reference points, or when a designer is scribing fast radial lines on a pattern, the damping mechanism ensures the motion remains smooth and controlled, preserving the intended line quality and arc fidelity.

By segmenting the track and employing elastically preloaded arms, this embodiment leverages passive mechanical compliance to achieve a high degree of positional and dynamic control without introducing friction-heavy or wear-prone components. It strikes a balance between stability and ease of movement, ultimately enhancing the ergonomic performance and long-term reliability of the multifunctional geometry instrument.

In an embodiment, the anchoring pivot pin (106) is retractable and operably connected to a slide-actuated deployment mechanism integrated within the instrument body, wherein the mechanism comprises a spring-biased cartridge with a cylindrical sleeve configured to house the pin in a vertically slidable arrangement, wherein downward actuation of a side-mounted deployment tab compresses the internal spring and lowers the pin through an aperture in the body to engage with a work surface, wherein the mechanism enables user-selective activation of the compass mode without manually handling the pin; and wherein the pin deployment mechanism further includes a locking cam mounted on a pivot axle and coupled to a torsional spring, wherein rotation of the cam aligns a flat segment with the pin sleeve to permit vertical translation, wherein upon release of the actuation tab, the cam rotates back to its locking position under torsional spring force.

In this embodiment, the anchoring pivot pin (106) is designed as a retractable component, integrated with a sophisticated slide-actuated deployment mechanism that enables hands-free engagement of the compass functionality. This system is embedded within the instrument's body and allows users to selectively deploy or retract the pivot pin without directly touching it, thus improving ease of use, safety, and mechanical precision-particularly beneficial for children or in classroom environments where manual handling of sharp components is discouraged.

This downward extension allows the pin to function as the central anchoring point for compass operations. For example, to draw a circle, the user can place the instrument on the paper, press the deployment tab to anchor the pin, and then use the slider to rotate the marking implement around the fixed center without needing to manually insert or adjust the pin.

To maintain safety and controlled operation, the system further incorporates a locking cam mechanism. This cam is mounted on a pivot axle and is coupled to a torsional spring, forming a self-resetting mechanical latch. When the deployment tab is actuated, the cam is rotated to a position where a flat segment aligns with the cylindrical sleeve, allowing it to translate freely and lower the pin. Once the user releases the tab, the torsional spring automatically rotates the cam back to its original locking position. In this state, the cam's curved surface restricts further vertical motion, effectively locking the pin in place to prevent accidental retraction or uncontrolled movement during compass use.

This locking ensures that the pivot pin remains stable even when the user applies radial torque during arc drawing. Additionally, when the user is finished with compass mode, they can reverse the tab action to retract the pin, and the mechanism restores to its safe, locked configuration. The fully integrated nature of this deployment system eliminates the need for external components or manual assembly and offers an intuitive, secure, and efficient user experience. The embodiment significantly elevates the multifunctionality of the instrument by combining traditional compass anchoring with modern, tool-less, and tactile actuation techniques.

In an embodiment, the writing insert holder (104a) includes an integrated anti-rotation guide system comprising a pair of vertical guide vanes that extend from the inner wall of the holder cavity and engage longitudinal grooves formed on the surface of the inserted writing instrument, wherein said guide vanes constrain the rotational freedom of the writing element within the holder and ensure angular consistency of the marking tip relative to the slider's axis during usage.

In this embodiment, the writing insert holder (104a) is augmented with an anti-rotation guide system designed to maintain precise angular alignment of the marking instrument during all drawing operations, particularly in tasks requiring consistent orientation of the writing tip. The system comprises a pair of vertical guide vanes that project inwardly from the inner wall of the cylindrical holder cavity. These vanes are positioned diametrically opposite one another and are molded integrally into the inner surface of the holder to ensure rigid alignment and durability over prolonged use.

The vanes are dimensioned and spaced to engage directly with corresponding longitudinal grooves or flat segments provided on the outer surface of compatible writing instruments such as hexagonal pencils, mechanical pencil barrels with alignment slots, or custom-marked stylus casings. When the instrument is inserted into the holder, the guide vanes slide into these grooves and lock the tool's orientation relative to the slider body. This interface eliminates the possibility of unintended rotational play, which could otherwise introduce errors in line angle, arc curvature, or directionality during compass or oblique drawing functions.

This anti-rotation feature is particularly critical when the writing instrument is used in conjunction with angular indexing systems or rotational ratcheting mechanisms described in other embodiments. For instance, when a user sets the writing insert at a 45° angle using a turret-based angular adjustment system, the guide vanes ensure that the tip of the pencil or pen remains fixed in that orientation, preventing twisting that could cause asymmetric line thickness or trajectory deviation.

Moreover, the presence of this constraint mechanism enhances consistency in applications such as technical drafting, pattern marking, and geometric constructions where multiple arcs or lines must be drawn with uniform alignment. For example, a designer drawing concentric circles or a student performing radial bisecting constructions can rely on the writing tip maintaining the same directional alignment, resulting in sharper and more consistent output.

In an embodiment, the slider (104) includes an over-travel protection mechanism comprising a limit stop formed by a transverse abutment ridge located at the terminal end of the guide track, wherein said ridge interfaces with a protruding bumper tab located on the trailing edge of the slider, wherein the bumper tab is fabricated from an elastomeric compound and is dimensioned to deform upon impact to prevent structural damage or separation of the slider under excessive translational force.

In this embodiment, the slider (104) is equipped with an over-travel protection mechanism that safeguards the structural integrity of both the slider and the guide track during excessive or abrupt translational movement. This mechanism is especially important in contexts where the instrument is used by children or in fast-paced drawing environments, where the slider may be unintentionally pushed beyond its designed operating range.

The over-travel protection system comprises two key structural elements: a limit stop and a deformable bumper tab. The limit stop is formed as a transverse abutment ridge integrally molded at the terminal end of the guide track. This ridge serves as a physical barrier that defines the maximum permissible travel of the slider along the longitudinal axis of the track. Correspondingly, the slider features a protruding bumper tab located on its trailing edge—i.e., the end opposite the writing insert holder. This bumper tab is strategically positioned to interface with the limit stop just before the slider reaches the physical end of the track.

This controlled deformation not only absorbs mechanical shock but also prevents the slider from snapping out of the guide track due to momentum. For example, if a user quickly retracts the slider after drawing a large arc or performs a fast sweep while transferring a distance measurement, the bumper tab engages the limit stop and safely halts the slider without jarring feedback or structural stress. This is particularly beneficial for protecting the longevity of the instrument under repeated use.

Moreover, the elastomeric material is selected and dimensioned to rebound after deformation, allowing the bumper to recover its original shape without permanent indentation or loss of functionality. The embodiment thereby introduces a passive yet highly effective protective feature that enhances durability, reduces mechanical wear, and ensures continued smooth operation of the multifunctional geometry instrument, even under aggressive usage conditions.

In an embodiment, the instrument further comprises a retractable stabilizing foot deployed at an intermediate position along the underside of the elongated body, wherein the stabilizing foot is spring-loaded and configured to contact the drawing surface during compass operation to provide three-point mechanical support, wherein deployment of the foot is synchronized with the extension of the pivot pin by a mechanical linkage consisting of a rocker arm and a control rod.

In this embodiment, the multifunctional geometry instrument is further enhanced with a retractable stabilizing foot designed to improve balance and structural steadiness during compass operation. The stabilizing foot is strategically located at an intermediate position along the underside of the elongated planar body, providing a critical third point of contact with the drawing surface. This configuration creates a tripod-like mechanical support system, comprising the pivot pin, the stabilizing foot, and the slider-mounted writing insert. Such a three-point contact arrangement significantly reduces wobbling, slipping, or tilting of the instrument while drawing arcs or circles, especially with larger radii or on low-friction surfaces like laminated paper or drafting film.

The stabilizing foot is spring-loaded and vertically retractable, allowing it to extend downward only during compass use and remain flush with the body during other functions, such as when using the instrument as a straightedge or divider. Its deployment is not manual but rather mechanically synchronized with the extension of the pivot pin through an internal linkage mechanism. This linkage includes a rocker arm and a control rod: when the user activates the slide-actuated deployment tab to extend the pivot pin, the motion is transmitted via the control rod to pivot the rocker arm. The rocker arm then rotates or tilts in response, pushing the stabilizing foot downward until it makes firm contact with the surface.

This synchronized deployment ensures that both the pivot pin and the stabilizing foot are activated simultaneously and uniformly, eliminating the need for additional user steps or adjustments. As a result, the instrument becomes immediately stable as soon as it is converted into compass mode. For example, when a student presses the side tab to lower the pivot pin, the stabilizing foot extends at the same moment, pressing against the drawing sheet to form a stable base, thereby minimizing rotational tilt when tracing arcs with wide angular sweeps.

Additionally, the spring-loading of the stabilizing foot allows it to conform to minor surface irregularities and ensures that it retracts smoothly when the pivot pin is withdrawn. The components of the linkage mechanism are miniaturized and enclosed within the body, preserving the sleek profile and ergonomic feel of the instrument. Overall, this embodiment introduces a critical structural element that substantially enhances user control, safety, and drawing accuracy during compass-related operations, making the instrument robust enough for advanced technical use yet intuitive for learners and general users.

In an embodiment, the linear translation of the slider is regulated by a micrometer-adjustment screw mounted along a parallel axis adjacent to the guide track, wherein the screw is coupled to the slider through a traveling nut mechanism, wherein rotation of the screw by a user causes fine linear movement of the slider with displacement resolution less than 0.25 mm per revolution.

In this embodiment, the multifunctional geometry instrument is equipped with a high-precision linear adjustment mechanism that enables users to finely control the translational position of the slider (104) along the guide track. This is particularly advantageous in scenarios requiring exact radius settings or incremental distance measurements, such as in advanced drafting, precise geometric constructions, or repeatable engineering layouts.

The mechanism comprises a micrometer-adjustment screw mounted longitudinally within the instrument body, positioned parallel to and adjacent to the guide track. This screw serves as a linear actuator and is rotatably mounted at both ends within low-friction bushings or bearings to allow smooth and controlled turning by the user. Affixed to the slider is a traveling nut, a threaded component that engages the threads of the micrometer screw. As the screw is rotated manually—either by turning a knurled adjustment knob or a precision dial—the threaded interaction causes the traveling nut to move incrementally along the axis of the screw, thereby translating the attached slider along the guide track.

Because the screw's pitch is finely machined, the system offers a displacement resolution of less than 0.25 mm per full revolution of the screw. This means that even minimal rotations of the adjustment knob result in small, highly controlled linear movements of the slider, allowing users to set very specific radial distances from the pivot pin to the writing insert holder. For instance, a user could draw multiple circles with radii differing by only tenths of a millimeter—such as 5.00 mm, 5.25 mm, 5.50 mm, and so forth—without relying on manual scale estimation or visual alignment.

The micrometer screw mechanism also serves to lock the slider in place once the desired position is reached. Due to the self-locking nature of fine-pitched threads, the slider will remain stationary under normal operational loads, including the radial forces applied during compass movement or distance transfer operations. This ensures consistent accuracy and prevents unintended drift due to hand pressure or mechanical vibration.

This embodiment elevates the functionality of the geometry instrument from a basic mechanical aid to a precision tool suitable for professional use, while still retaining accessibility for students or hobbyists. It seamlessly integrates a metrological-grade control system within a compact, user-friendly form factor, enabling precise, repeatable, and effortless setting of linear positions without the need for external measuring instruments.

The present invention pertains to an integrated multi-functional geometry device, wherein the device is designed in a manner that it can be used to perform the functions of a compass, ruler, divider, and pencil holder, wherein all these features are integrated within a single device. The device comprises an elongated scale body with measurement markings, a centrally mounted movable slider configured to hold a pencil or pen, and a twist-lock pin at one end to act as a rotational pivot. By adjusting the slider, users can draw circles, arcs, bisect lines or angles, and also draw straight lines with accuracy and efficiency.

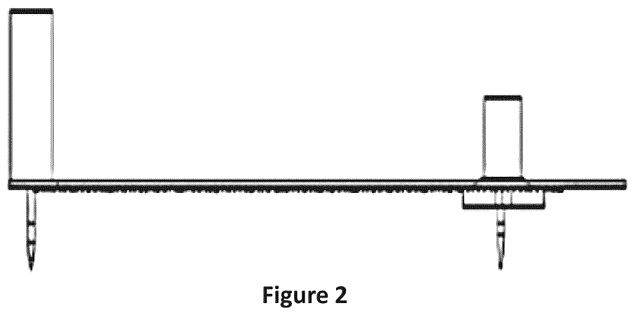

FIG. 2 illustrates a drawing depicting the front view of the device, in accordance with an embodiment of the present disclosure.

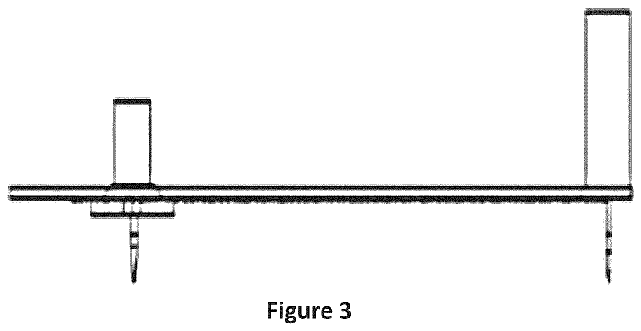

FIG. 3 illustrates a drawing depicting the back view of the device, in accordance with an embodiment of the present disclosure.

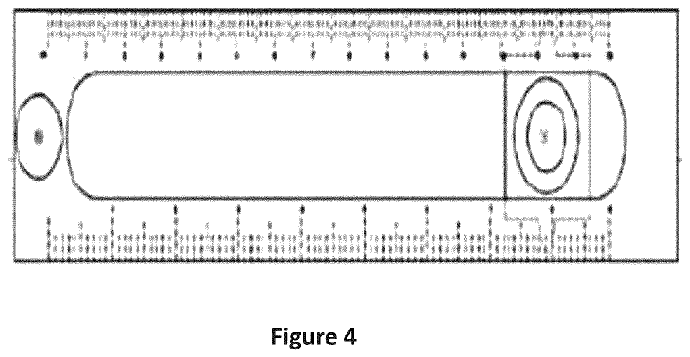

FIG. 4 illustrates a drawing depicting the top view of the device, in accordance with an embodiment of the present disclosure.

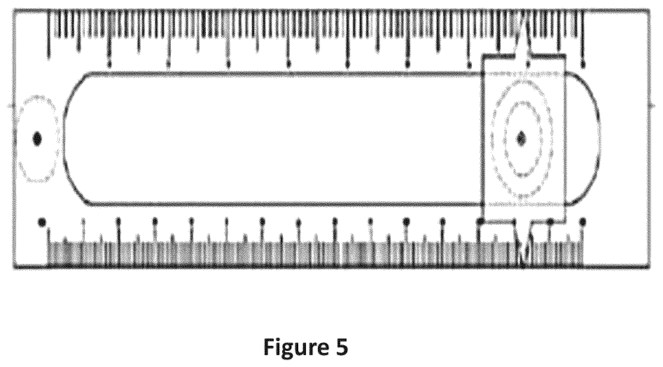

FIG. 5 illustrates a drawing depicting the bottom view of the device, in accordance with an embodiment of the present disclosure.

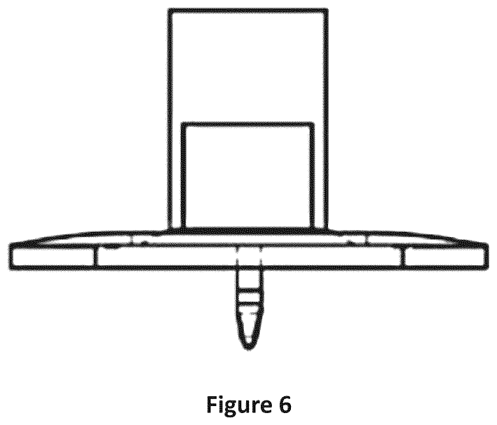

FIG. 6 illustrates a drawing depicting the right side view of the device, in accordance with an embodiment of the present disclosure.

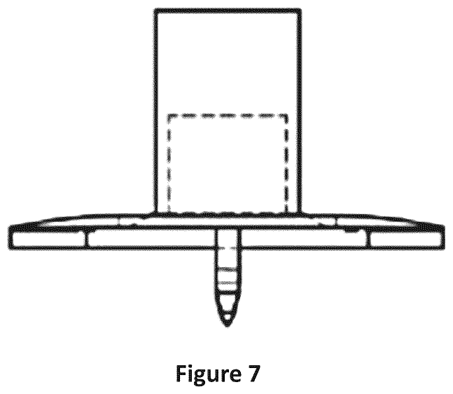

FIG. 7 illustrates a drawing depicting the left side view of the device, in accordance with an embodiment of the present disclosure.

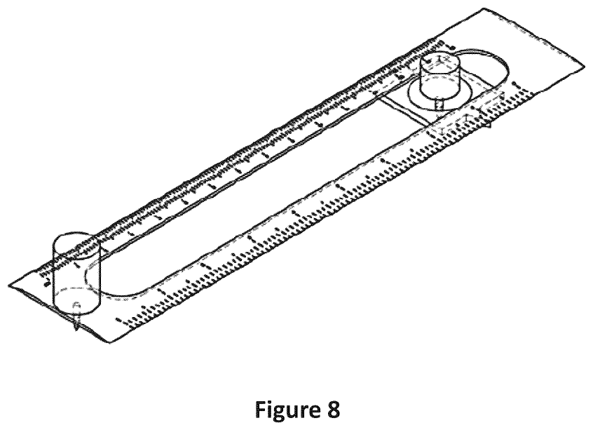

FIG. 8 illustrates a drawing depicting the perspective view of the device, in accordance with an embodiment of the present disclosure.

The present invention provides an integrated multi-functional geometry device. The device comprises an elongated flat body with linear measurement marking on at least one surface; a central slider mechanism configured to move linearly along a guide track integrated into the body; a writing instrument insert holder mounted on said slider, configured to hold a pencil; and an anchoring pin housed at one end of the body, wherein the slider and the anchoring pin together facilitates the drawing of geometric construction, including circles, arcs, and bisection lines or angles. The liner measurement of the elongated flat body facilitates marking both metric graduations, up to 15 cm, and imperial graduations, up to 6 inches. The anchoring pin comprises a stainless-steel rod of 3 mm diameter and is secured using a holder embedded into the body of the instrument at the zeroth marking. The central slider comprises a top-mounted grip knob and a recessed cavity for retaining a writing insert, and is configured to move from the 2.5 cm marking up to the maximum length of the instrument with position-locking capability.

In an embodiment, the device is configured to be tilted and supported by the extremities of the slider and holder to function as a scale for drawing straight lines.

In an embodiment, the slider and the pin together define a radius, and by rotating the slider around the fixed anchoring pin, the user can draw circles or arcs of varying radii up to the full length of the instrument. The device is designed in a manner to bisect a line or angle, which is achieved by using the movable slider to draw intersecting arcs from defined reference points.

In an embodiment, the device is fabricated using polycarbonate plastic with rounded edges for safe handling, wherein the device has a total weight of less than 20 grams to ensure portability and child safety.

The proposed integrated multi-functional geometry device is compact, lightweight, and handheld device, capable of performing the function of at least four different traditional geometry tools: compass, scale/ruler, divider, and pencil. The device consists of a flat, elongated body with measurement scales on both sides, a movable slider in a center track, and a detachable anchoring pin placed near the start of the scale. This allows for geometric constructions like drawing straight lines, circles, arcs, and bisecting angles or segments, all from a single device.

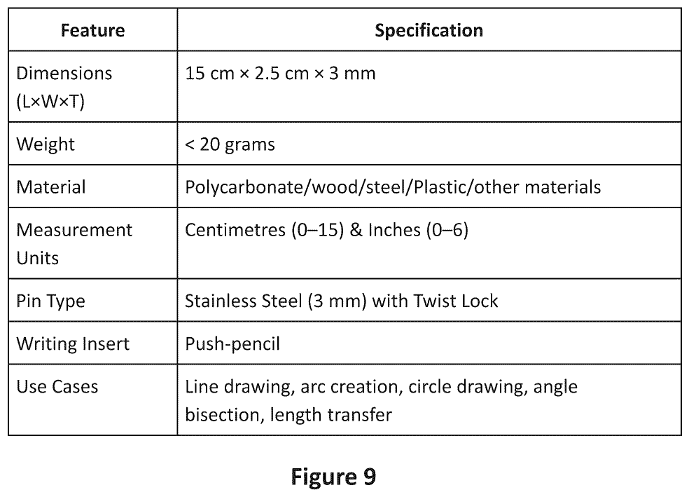

FIG. 9 illustrates a table showing the specification of the integrated multi-functional geometry device, in accordance with an embodiment of the present disclosure.

Referring to the table as shown in FIG. 9, the device comprises a main body, a central slider, and a pin holder. The main bod has a length of 15 cm, width of 2.5 cm, and thickness of 3-4 mm. The device is fabricated using polycarbonate plastic, semi-transparent, or other material. The main body has rounded corners and soft edges to enhance grip and avoid injuries. The main body has printed or engraved linear measurements scale, in both metric and imperial measurements, up to 15 cm, and 6 inches, respectively. The central slider of the device is mounted within a groove running along the body, wherein the central slider has a knob for grip on top, and has an integrated writing instrument inset holder at the bottom, which allows for holding standard push pencil, pen refills, or styluses, wherein the central slider slides smoothly from 2.5 cm to 15 cm with position-locking. The pin holder is located at 0 cm at the end of the device, containing a 3 mm stainless steel pin, allowing it to act as a pivot point during circular or arc drawing.

The device can work as a ruler, a compass, a divider, and even used for bisecting angles or lines. When functioning as a ruler, the flat body allows for drawing straight lines, and can be tilted slightly and supported by slider with pin extremities. For using as compass, the user rotates the pencil top around the fixed pin to draw circles and arcs, wherein the slider is set to the desired radius and locked. For using as a divider, the transferring distance is made possible by marking reference points using fixed and sliding parts of the instrument. For bisecting angles or lines, the intersecting arcs can be drawn using the same rotational operation to bisect lines or angles.

The proposed device offers several advantages over the traditional geometry tools, including time saving, safety, precision, ease of use, portability, and multi-functionality. The device reduces construction time by up to 70% due to fewer steps and no switching between instruments. The device has no exposed metal components except for a small pin. The device allows for fine control with accuracy upto 0.5 mm. The device requires minimal setup and training. The device is portable, lightweight, and compact, which makes it ideal for school bags and pencil pouches. The device can operate as at least 4 geometrical tool, making it multi-functional in nature.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A multifunctional geometry instrument configured to perform the functions of a compass, ruler, divider, and pencil holder, the instrument comprising:
an elongated planar body having a linear measurement scale marked along at least one surface, the body comprising a top face, a bottom face, a longitudinal central axis, and a guide track disposed along said axis;
a slider member mounted within the guide track and configured to translate along the longitudinal axis, wherein the slider member comprises a writing insert holder configured to retain a pencil, pen, or marking element;
an anchoring pivot pin disposed proximate to a first end of the elongated planar body, the pin being secured within a cavity or recess aligned at or near the zeroth mark of the linear scale, and
a locking mechanism integrated with the slider member, configured to selectively fix the position of the writing insert relative to the pivot pin, wherein the slider member and anchoring pivot pin together define a radial arm allowing the instrument to perform circular and arc-drawing operations, line bisecting, and distance transferring tasks by rotational movement of the writing insert around the anchoring pin.

2. The multifunctional geometry instrument claim 1, wherein the linear measurement scale includes both metric units up to 15 centimeters and imperial units up to 6 inches, wherein the pivot pin comprises a stainless steel rod having a diameter in the range of 2.5 mm to 3.5 mm, and is held within a recessed conical socket formed in the body to allow stable rotational anchoring; and wherein the writing insert holder comprises a cylindrical cavity formed within the slider and a compression fit or clamping mechanism to secure various marking instruments selected from pencils, pen refills, mechanical pencils, or styluses.

3. The multifunctional geometry instrument claim 1, wherein the slider member further comprises a grip knob disposed on an upper surface, and a recessed cavity aligned orthogonally to the guide track for improved ergonomic handling and vertical pressure application during use; wherein the locking mechanism comprises a friction-based twist-lock system or detent latch that enables discrete positional locking of the slider along predefined measurement intervals; and wherein the body is fabricated from semi-transparent polycarbonate plastic with rounded corners and softened edges, and wherein the entire instrument has a total weight not exceeding 20 grams for improved portability and safe handling by children.

4. The multifunctional geometry instrument claim 1, wherein the elongated planar body is configured to be tilted slightly and supported on the slider and the pivot end to allow stable drawing of straight lines when used in ruler mode; wherein the slider and anchoring pin are configured such that rotational displacement of the slider about the pin allows for drawing of concentric or overlapping arcs by adjusting the radial distance via the guide track; and wherein the slider mechanism enables drawing of intersecting arcs from two or more reference points for the purpose of bisecting an angle or a linear segment, emulating the functionality of a traditional compass and divider combination.

5. The multifunctional geometry instrument of claim 1, wherein the slider member is mechanically coupled to the guide track by a pair of opposed lateral protrusions extending orthogonally from the slider base into corresponding longitudinal retention channels formed within the inner sidewalls of the guide track, wherein said protrusions are dimensioned to provide a snap-fit engagement allowing translational movement with axial constraint, wherein the engagement further provides anti-lift resistance to prevent unintentional detachment of the slider from the body during operational use involving torsional forces; and wherein the retention channels of the guide track include a series of detent notches or micro-indentations spaced along the length of the track, wherein a spring-loaded ball plunger is embedded within the slider base and configured to engage said notches to allow tactile feedback and discrete radial locking during use as a compass, wherein the plunger is biased by a compressible elastomeric pad or coiled micro-spring positioned within a vertical recess of the slider base to provide adjustable locking resistance.

6. The multifunctional geometry instrument of claim 1, wherein the writing insert holder comprises a vertically oriented clamping cavity defined by two opposing semi-cylindrical jaws, wherein the jaws are connected via an integrated hinge joint and tightened by a micro-threaded screw accessible from the top surface of the slider, wherein the screw drives a compressive plate that applies symmetrical force across the inner walls of the cavity to secure marking instruments of varying diameters without inducing lateral wobble during rotation; and wherein the integrated hinge joint comprises a flexural web formed from a living hinge geometry molded as a single piece with the slider body, wherein said hinge exhibits elastic deformation limited to a maximum angular deflection of 15 degrees on either side of neutral to facilitate controlled opening and closing of the clamp cavity, wherein the web is oriented orthogonal to the direction of slider translation to preserve axial alignment of the writing instrument.

7. The multifunctional geometry instrument of claim 1, wherein the anchoring pivot pin is coupled to a recessed rotary locking collar housed within a cylindrical cavity formed into the instrument body, wherein the collar includes a plurality of radial ridges configured to engage a corresponding toothed raceway embedded in the body cavity wall, wherein rotational tightening of the collar by a user compresses the collar axially to lock the pin in place, while counter-rotation releases the engagement to permit safe retraction or repositioning of the pin; and wherein the pivot pin is integrally connected to a vertical shaft extending below the instrument body and terminating in a hemispherical footpad configured to rest flush against a drawing surface, wherein said footpad is surrounded by a silicone or elastomeric gasket ring bonded to the base of the body cavity, wherein the gasket ring provides both frictional anchoring during compass operation and shock absorption to prevent slippage when rotational torque is applied via the slider.

8. The multifunctional geometry instrument of claim 1, wherein the guide track includes a secondary alignment rib projecting upward from the track base and extending longitudinally along its centerline, wherein the slider comprises a matching channel that mates with the rib to constrain motion strictly along a linear axis, wherein the interaction of the rib and channel prevents skew or torsional misalignment of the slider during force-intensive rotational usage in compass or bisecting mode; and wherein the slider includes dual lateral stabilization fins extending downward from its base, said fins being received in corresponding vertical grooves within the track walls, wherein the combination of fins and the central alignment rib forms a three-point kinematic constraint system that preserves planarity of motion and maintains orthogonality of the writing axis during all drawing operations.

9. The multifunctional geometry instrument of claim 1, wherein the slider is equipped with a torsion spring-loaded ratcheting disk mounted coaxially with the writing insert holder, wherein the ratcheting disk includes a series of radial teeth configured to engage a locking pawl mounted within the slider housing, wherein selective depression of a release button on the slider disengages the pawl, allowing rotational repositioning of the writing insert holder to facilitate oblique line or angled arc drawing.

10. The multifunctional geometry instrument of claim 1, wherein the slider is mechanically connected to a tension-biased positioning mechanism comprising an internal helical spring coupled between a fixed anchor post embedded within the guide track and a rearward-facing tab extending from the slider body, wherein the spring applies a return force to bias the slider toward the anchoring pivot when no external force is applied, wherein said mechanism provides automated radial reset after each arc or circle drawing operation to enhance efficiency in repeated constructions.

11. The multifunctional geometry instrument of claim 1, wherein the slider comprises an integrated dial indicator positioned adjacent to the linear scale and operably connected to the slider's translational position via a rack-and-pinion mechanism, wherein the rack is embedded along the underside of the guide track, and the pinion is rotationally mounted within the slider and configured to drive the indicator dial, wherein the dial dynamically displays real-time radius values as the slider is moved, enabling precise and immediate radius setting without manual reading of the linear scale.

12. The multifunctional geometry instrument of claim 1, wherein the writing insert holder is further configured with an angular indexing feature comprising a rotary turret with a detented rotational mount, wherein the turret allows selectable angular orientations of the writing implement in fixed increments of 15°, wherein each angular position is maintained by engagement of a spring-biased indexing pin with a corresponding radial groove formed on the turret's periphery.

13. The multifunctional geometry instrument of claim 1, wherein the guide track is segmented into a primary linear slot and two lateral stabilization grooves, wherein the underside of the slider includes a central gliding rail and two flexible lateral arms extending downward from either side, wherein each flexible arm includes a convex cam surface that presses against the groove wall to induce elastic preload, wherein said configuration allows damping of mechanical vibration and stabilizes motion during rapid drawing actions.

14. The multifunctional geometry instrument of claim 1, wherein the anchoring pivot pin is retractable and operably connected to a slide-actuated deployment mechanism integrated within the instrument body, wherein the mechanism comprises a spring-biased cartridge with a cylindrical sleeve configured to house the pin in a vertically slidable arrangement, wherein downward actuation of a side-mounted deployment tab compresses the internal spring and lowers the pin through an aperture in the body to engage with a work surface, wherein the mechanism enables user-selective activation of the compass mode without manually handling the pin; and wherein the pin deployment mechanism further includes a locking cam mounted on a pivot axle and coupled to a torsional spring, wherein rotation of the cam aligns a flat segment with the pin sleeve to permit vertical translation, wherein upon release of the actuation tab, the cam rotates back to its locking position under torsional spring force.

15. The multifunctional geometry instrument of claim 1, wherein the writing insert holder includes an integrated anti-rotation guide system comprising a pair of vertical guide vanes that extend from the inner wall of the holder cavity and engage longitudinal grooves formed on the surface of the inserted writing instrument, wherein said guide vanes constrain the rotational freedom of the writing element within the holder and ensure angular consistency of the marking tip relative to the slider's axis during usage.

16. The multifunctional geometry instrument of claim 1, wherein the slider includes an over-travel protection mechanism comprising a limit stop formed by a transverse abutment ridge located at the terminal end of the guide track, wherein said ridge interfaces with a protruding bumper tab located on the trailing edge of the slider, wherein the bumper tab is fabricated from an elastomeric compound and is dimensioned to deform upon impact to prevent structural damage or separation of the slider under excessive translational force.

17. The multifunctional geometry instrument of claim 1, wherein the instrument further comprises a retractable stabilizing foot deployed at an intermediate position along the underside of the elongated body, wherein the stabilizing foot is spring-loaded and configured to contact the drawing surface during compass operation to provide three-point mechanical support, wherein deployment of the foot is synchronized with the extension of the pivot pin by a mechanical linkage consisting of a rocker arm and a control rod.

18. The multifunctional geometry instrument of claim 1, wherein the linear translation of the slider is regulated by a micrometer-adjustment screw mounted along a parallel axis adjacent to the guide track, wherein the screw is coupled to the slider through a traveling nut mechanism, wherein rotation of the screw by a user causes fine linear movement of the slider with displacement resolution less than 0.25 mm per revolution.
